(19) United States
(12) Patent Application Publication
(10) Pub. No.: US 2009/0009902 A1
(43) Pub. Date: Jan. 8, 2009

(54) Method for Con-trolling a Data Storage System

(76) Inventors: Bernd Klee, Kreuztal (DE); Gundolf Gremler, Wilnsdorf (DE); Marco Vogele, Siegen (DE)

Correspondence Address: SHLESINGER, ARKWRIGHT & GARVEY LLP, 1420 KING STREET, SUITE 600, ALEXANDRIA, VA, 22314, US

(21) Appl. No.: 12/224,599

(22) PCT Filed: Nov. 1, 2006
(86) PCT No.: PCT/EP2006/010492

§ 371 Date: Sep. 2, 2008

(51) Int. Cl. G11B 15/18

(52) U.S. Cl. 360/69

(57) ABSTRACT

A system comprises a data management system, a media transport unit with a plurality of bins, each bin having a bin specific capacity for storing storage media units, at least one data processing unit and at least one loader mechanism for selectively moving a media unit from its actual location to another location within the media transport unit, a number of storage media units loaded in particular ones of the bins, and a control unit functionally interconnecting as programming interface said data management system and said media transport unit. The control unit is configured to emulate functionalities of a media changer with elective media access by generating, updating and managing a table, the table having a number of rows, wherein each storage media unit is assigned to exactly one of those rows which are identified as unique virtual slots. Each row of said table comprises fields that are continuously updated to provide actual position information about the assigned storage media unit, so that in case of a requested access to a specific one of the number of storage media units the control unit can unambiguously determine the actual position of the specific storage media unit for that access can be achieved, if required, by an appropriate stock transfer of the storage media units amongst the bins.

### FIELD OF THE INVENTION

The present invention relates to data storage. More particularly, the present invention relates to a method for controlling a data storage system by emulating a media changer with selective media access on the basis of a media transport unit. The present invention further relates to a corresponding system, a computer program, a computer program product and a computer-readable medium.

Digital data storage devices for storing computer data on exchangeable storage media, for example on optical storage media such as CD, DVD, BD, are required, due to the relatively small storage capacity of a single exchangeable storage medium to use a multiplicity of storage media in order to fulfil the requirements a user has with respect to the complete capacity of such a system. One of the main tasks of a data management process in such a system is the automatic distribution of data to be stored on the single storage media and the generation of management information on the basis of which the stored data can be retrieved and delivered to a user when access to the data is required.

Currently, such systems generally use for cost reduction, a media changer also known as media library. Media changers are known in the art. Media changers provide apparently simultaneous access to a plurality of exchangeable storage media without the need for a corresponding number of data transfer devices such as reading or writing devices. Within such media changers a plurality of storage media are disposed in separate slots such that every single data medium can be selectively moved by a grasp and transport mechanism out of the slot and into a data communication device or vice versa. The transporting times for all slots are almost the same. The number of data communication devices which are incorporated within such a media changer is generally considerably smaller than the number of slots for the storage media.

However, for the benefit of cost reduction it would be desirable to provide a possibility to emulate the functionality of such a media changer by means of a system or device which has low cost.

### SUMMARY OF THE INVENTION

In order to provide the possibility for emulating functionalities of a media changer with elective media access, the present invention provides a system with the features of claim 1 and a corresponding method with the features of claim 12.

According to claim 1, the present invention proposes a system comprising a data management system, a media transport unit with a plurality of bins, each bin having a bin specific capacity for storing storage media units, at least one data processing unit and at least one loader mechanism for selectively moving a storage media unit from its actual location to another location within the media transport unit, a number of storage media units, the number being smaller or equal to the sum of the bin specific capacities and further available storing capacities within the media transport unit reduced by the highest bin capacity, and a control unit functionally interconnecting as programming interface the data management system and the media transport unit, wherein the control unit is configured to emulate functionalities of a media changer with selective media access by generating, updating, and managing a table, the table having a number of rows, the number of rows being equal to the sum of the bin specific capacities and further available storing capacities within the media transport unit reduced by the highest bin capacity, wherein each storage media unit is assigned to exactly one of those rows, which are identified as unique virtual slots, respectively, each row further comprising fields to be continuously updated to provide actual position information about the respective storage media unit, so that in the case of a requested access to a specific one of the number of storage media units, the control unit can unambiguously determine the actual position of said storage media unit so that access can be achieved, if required, by an appropriate stock transfer of the storage media units amongst the bins.

According to another aspect of the present invention a method is provided for controlling the data storage system comprising a data management system, a media transport unit with a plurality of bins, each bin having a bin specific capacity for storing storage media units, at least one data processing unit and at least one loader mechanism for selectively moving a storage media unit from its actual location to another location within the media transport unit, and a number of storage media units, the number being smaller or equal to the sum of the bin specific capacities and further available storing capacities within the media transport unit reduced by the highest bin capacity. The method comprises the steps of providing a control unit functionally interconnecting as programming interface the data management system and the media transport unit, generating a table to be managed and updated by the control unit, the table having a number of rows, the number of rows being equal to the sum of the bin specific capacities and further available storing capacities within the media transport unit reduced by the highest bin capacity, assigning each storage media unit to exactly one of those rows, identifying each row as a unique virtual slot, and providing each row with further fields to be continuously updated to provide actual position information about the respective storage media unit so that in case of a requested access to a specific one of the number of storage media units the control unit can unambiguously determine the actual position of the storage media unit so that access can be achieved, if required, by an appropriate stock transfer of the storage media units amongst the bins.

Another aspect of the present invention refers to a control unit which functionally interconnects as programming interface a data management system and a media transport unit with a plurality of bins, each bin having a bin specific capacity for storing storage media units, at least one data processing unit and at least one loader mechanism for selectively moving a storage media unit from its actual location to another location within the media transport unit, wherein the control unit is configured to emulate functionalities of a media changer with elective media access by generating, updating and managing a table. Thereby, the table has a number of rows, the number of rows being equal to the sum of the bin specific capacities and further available storing capacities within the media transport unit reduced by the highest bin capacity, wherein each storage media unit is assigned to exactly one of these rows which are identified as unique virtual slots, respectively, each row further comprising fields to be continuously updated to provide actual position information about the respective storage media unit, so that in the case of a requested access to a specific one of the number of storage media units the control unit can unambiguously determine the actual position of the storage media unit so that access can be achieved, if required, by an appropriate stock transfer of the storage media units amongst the bins.

The idea of the present invention is based on the fact that a media transport unit also allows an apparently selective access to a desired one of a number of storage media units disposed in a particular bin by an appropriate stock transfer of the storage media unit's which are lying on top of the desired storage media unit, to another bin.

The maximum number of storage media units N_{MAX} that can be located in the bins and in the other elements of a media transport unit is limited. This limitation is required because it must be possible to perform a stock transfer of storage media units from a particular bin to another bin and/or to any of the other elements in order to achieve access to any of the storage media units located in said particular bin. The following formulas and equations define N_{MAX}. In the formulas, B denotes the number of bins, C is the sum of the capacities of all bins, Cᵢ denotes the capacity of a particular bin, and C_{MAX} is the highest capacity. The symbol Δ represents the number of the other elements (e.g. additional slots or data processing units) of a media transport unit that can be used to store storage media units, reduced by the number of such elements that shall not be used for this purpose in an embodiment. For example, data processing units are typically not used for storing storage media units.

$$C = {\sum }_{i = 1}^{B} {C}_{i}$$

$${C}_{MAX} = {MAX}_{i = 1 … B} ( {C}_{i} )$$

$${N}_{MAX} = C - {C}_{MAX} + 1 + Δ$$

This formula assumes that the media transport unit is able to report the number of storage media units actually located in the bins. If this assumption is not correct, N_{MAX} should be reduced by 1.

The position information provided in each row of the table can comprise an identity of the bin to which the respective storage media unit is assigned, a concrete position within that bin and an actual address of a location where the respective storage media unit is actually located within the media transport unit.

The bins and the positions within the corresponding bins can be identified by an integer, respectively, whereby zero is placeholder for no bin and no position within a bin, respectively, thus indicating that either no storage media unit is assigned to the respective row or a storage media unit assigned to the respective row is actually located at another location within the media transport unit which can be derived from the actual address which is provided in another field of the row.

The data processing unit incorporated within the media transport unit comprises a data communication unit and/or a printing unit suitable for the number of storage media units. It is also possible that the data processing unit comprises a plurality of data communication units and/or a plurality of printing units.

The individual components of a media changer such as slots, devices, grasp and transport mechanisms, are generally designated as elements. Each element is assigned a number, a so-called element address. These element addresses must be unique. Furthermore, the elements are arranged according to element types such as slot elements, data communication elements, transport elements and printing elements. The elements of each group are, respectively, assigned to a contiguous area of element addresses.

The starting point of each address area can be user defined, but the areas must not overlap. A storage system can scan the address areas which are assigned to the element types and therefore get all information concerning availability and number of different elements which are necessary for the operation of the media changer.

The essential difference between a media changer and a media transport unit consists in that a media transport unit does not comprise single slots. The data storage media are instead stacked on top of each other within appropriate bins.

The method according to the present invention emulates the slots of a media changer by means of the proposed table which is generated, updated and managed by the control unit as proposed by the present invention. The table comprises a number of rows, wherein the number of rows is equal to the maximum number of storage media units N_{MAX} that can be located in the bins and in the other elements of a media transport unit. Each row of the table corresponds to exactly one available slot element, wherein the number of each available slot element can be equal to the corresponding row number. The storage media units in the bins of the media transport unit can be assigned in arbitrary order to the single rows, whereby only one storage media unit can be assigned to each row. Each row can comprise other fields in order to provide further information about an actual location of a storage media unit assigned to that row. It is possible that one field of a row identifies the bin in which the storage media unit is actually located. A further field of a row can indicate the position which the corresponding storage media unit has within the stack of storage media units which are disposed in the corresponding bin. The positions within the bin can be designated such that the storage media unit which lies topmost within that bin gets position 1, the subjacent storage media unit gets position 2 and so on. However, any other enumeration concerning the positions, which should be preferably based on a reliable position designation, is also possible. In the case that the number of rows is higher than the number of storage media units which can be found within the bins, these rows, which cannot be assigned to a special storage media unit, emulate vacant slot elements. Besides information about the bin and the position of the storage media units within such a bin, also an actual element address of each storage media unit can be indicated in a further field of the table. On the basis of such information an inventory of a media changer can be emulated.

The assignment of storage media units within the media transport unit to the rows of the table must be made at the time of the first placing into operation of the media transport unit. However, the assignment can be arbitrary often repeated at a later date when the storage system requires a novel initialisation of the respective state of all elements.

In the prior art several media transport units are known which are able to determine the number of storage media units stacked within one bin by determining the height of each stack. On the basis of such information the assignment can be performed very efficiently. However, such procedure is based on the assumption, that all storage media units have the same thickness.

Such an assumption is not valid as, due to allowable manufacturing tolerances, the actual number of storage media units can marginally differ from the measured number. The above mentioned and recommended manner of designation of positions and the assignment of the storage media units to the corresponding rows allow to correct such afford when being detected during operation.

Other types of media transport units are not able to determine the number of storage media units which can be found in a bin, however, these media transport units can determine whether a bin is empty or not. In such a case a number can be determined by transferring all storage media units from an initially filled bin to an empty bin successively and thereby counting those storage media units. This procedure can be repeated as long as all storage media units within all initially filled bins are counted.

According to the invention the control unit generates and manages the table and stores it in a non-volatile memory accessible by the control unit. The table is stored in a non-volatile memory so that information about an actual state of the media transport unit is immediately available after shut-down and new start of the control unit. In the case that a media transport unit comprises a non-volatile memory which has sufficiently high storage capacity and which can be accessed by the control unit, the table can also be stored within that memory. However, every arbitrary non-volatile memory can be used for access by the control unit.

The control unit emulates functionalities of a programming interface of a conventional media changer. The co-function of such a programming interface of the control unit is the function that a storage system can transport selectively any arbitrary storage media unit from a starting element such as a slot element to a destination element such as a data communication device. The source element, the destination element and the transport element to be used are determined and identified by corresponding element addresses.

When the source element is a slot element, the control unit can determine by means of the above mentioned and described table the corresponding bin as well as the position of the storage media unit assigned to such bin. By means of stock transfer the desired storage media unit can be accessed. Thereby, the table has to be permanently updated since bins and positions are changed because of the stock transfer of the corresponding storage media units. Thereafter, the desired storage media unit can be transported to the destination element. In the case that the destination element is a slot element, the storage media unit can be disposed in an arbitrary bin. Afterwards the table has to be updated correspondingly. This aspect of the method according to the present invention makes it possible for the storage media units to be sorted by and by according to specific criteria, for example according to access frequency, in order to minimize the access time of storage media units which are often used. Since the access time to a specific storage media unit is generally proportional to the number of storage media units which lie upon the desired storage media unit, the access time is minimum if the specific storage media unit lies topmost within the available bins. However, any other criteria are possible. Information which is necessary for use of such criteria can be stored in further fields of the table.

Some media changers can turn storage media units, so that double-sided storage media units can be used. Thus, the storage capacity of a media changer can be duplicated. In case that the grasp and transport mechanism of a media transport unit provides the possibility to turn a storage media unit, the present invention can be used to emulate such functionality. In this case, the table has to be expanded by one field, which permanently indicates the actual orientation of the storage media unit.

Some media changers are able to provide supplement information which serve for identification of storage media units and which go beyond the mere provision of the element addresses of the slot elements. Such auxiliary information can comprise a barcode and/or a serial number and/or a volume tag which can be found on the corresponding storage media units. This information can be read by special reading devices such as scanning devices or cameras. This functionality can also be emulated by means of the present invention whereby the used media transport unit incorporates such a reading device. Moreover the printing device which is generally present can also be used to print such information onto the corresponding storage media units.

Additionally, most media changers provide an import-/export element. Such an import-/export element serves for exchanging storage media units between a user of the storage system and the media changer. By means of this element new storage media units can be imported from the outside in one of the other elements and available storage media units can be exported from one of these elements to the outside.

Both, the system and the method according to the present invention can be used to emulate this element and its functionality. However, the kind of emulation depends on the configuration of the used media transport unit. Thus, a specific bin, which is provided by some kind of media transport units for the purposes of temporarily storage of few storage media units, can be used as import-/export element. Another kind of media transport units provides a specific bin which is usually used to store faulty storage media units. Such a bin can also be used as export element. In the case that no specific bins are provided, a number of storage media units can also be selected manually out of a bin after having been positioned on the topmost positions within that bin. Vice versa, a number of storage media units to be imported can also be positioned manually by a user on the topmost positions of a specific bin.

Some media transport units offer the possibility to manually remove an entire bin (including the number of storage media units actually located in that bin) from the media transport unit and to insert an alternative bin in place of the removed bin (including the number of storage media units actually located in that alternative bin). By means of this feature the present invention can provide an extended import/export function. Basically, the control unit has to determine the number of the storage media units that are located in the alternative bin again when the alternative bin is inserted, and it has to update its table accordingly. In order to improve this process and provided there is information that can be used to unambiguously identify a particular bin, the control unit can keep the last known information about any particular bin that had been inserted in the past by copying and storing the related rows of the table and the identification information in an area of the non-volatile memory that is reserved and structured for the purpose of storing such information. The last known information about a particular bin can be updated and/or stored in the reserved area at the time when said bin is removed from the media transport unit. When a known bin is inserted in the media transport unit the next time, the control unit can read the identification information of the inserted bin, search for matching last known information about the inserted bin in said reserved area, and, provided the control unit finds matching last known information, it can adopt the matching last known information instead of determining it again. In an embodiment of the present invention, supplemental information found on storage media units as described above can be used to identify a bin. The control unit can read the supplemental information from the topmost storage medium of an inserted bin and can find matching last known information. In another embodiment, supplemental information that is stored on the bins can be used instead. Such supplemental information can comprise a barcode and/or a serial number and/or a RFID.

The control unit can also emulate various other functions that are provided by some media changers. This includes functions by means of which the assignment of element addresses or the functionality of the co-command described above can be modified so that parameters and behaviour can be adapted to specific needs.

In another embodiment of the present invention it is also possible that the control unit is further configured to interconnect as programming interface a data management unit and a conventional media changer. The control unit offers the data management system of the storage system exactly the same programming interface as it is offered by the control unit of a media changer. Therefore, the control unit can also be configured to control simultaneously a media transport unit and a conventional media changer so that no further control units are necessary in case that a media changer should also be used.

An extended media changer can, besides the standard slot elements, also provide a plurality of bins. Similar to this configuration, an extended media transport unit can, besides the standard bins, also provide a plurality of separate slot elements. In another embodiment of the present invention it is possible that the control unit is further configured to interconnect as programming interface a data management unit and such an extended media changer or media transport unit so that it combines the separate slot elements and the emulated slot elements into a single and contiguous space of addressable slot elements. In this configuration, the control unit can minimise the access times for most frequently accessed storage media units by storing the respective storage media units in the separate slot elements, while less frequently accessed storage media units are stored in the bins.

The present invention further relates to a computer program product with a computer-readable medium and a computer program stored on the computer readable medium with a program code that is suitable for carrying out a method according to the present invention.

Computer programs are also provided with a program code which is suitable for carrying out a method according to the present invention.

The present invention also relates to a computer-readable medium with a computer program stored thereon, the computer program comprising a program code which is suitable for carrying out the method according to the present invention.

Although the present invention is typically implemented using a computer, those skilled in the art will recognise that it can also be implemented on specialised hardware like a controller board equipped with a microprocessor and with non-volatile memory for storing a program code and/or the table.

Further features and embodiments of the invention become apparent from the description and the accompanying drawings.

It will be understood that the features mentioned above and those described hereinafter can be used not only in the combination specified but also in other combinations or on their own without departing from the scope of the present invention.

The invention is schematically illustrated in the drawings by way of an example embodiment and is explained in detail with reference to the drawings. It is understood that the description is in no way limiting on the scope of the present invention and is merely an illustration of a preferred embodiment of the invention.

It should be understood that while the invention is described in terms of a specific system, the invention has applications in a variety of storage systems which would benefit from the system or the method according to the present invention. It is intended that the system described in the specification and claims can be applied to any storage system unless the context requires otherwise.

### BRIEF DESCRIPTION OF THE DRAWINGS

In the drawings,

FIG. 1 is a schematic illustration of a media transport unit as it can be used in the present invention.

FIG. 2 is a schematic illustration of an embodiment of a storage system according to the present invention.

FIG. 3 to 5 depict sequential writing, reading and updating steps with a table according to a possible embodiment of the present invention.

FIG. 6 shows a flowchart describing an initialisation procedure when a control unit of an embodiment of the system according to the present invention is started the very first time.

FIG. 7 shows a flowchart describing a procedure for moving storage media units between elements as it can be realised by an embodiment of the present invention.

FIG. 8 shows a flowchart describing a routine for loading a storage media unit from a virtual slot as it can be realised by another embodiment of the present invention.

### DETAILED DESCRIPTION

The following description uses terms as defined in the ISO/IEC 9316:1995 standard, also called SCSI-2 standard, for Media Changer Commands. The standard is available at the International Organization for Standardization (ISO). This standard describes the commands that are usually provided by media changers and utilized by control units for this type of devices.

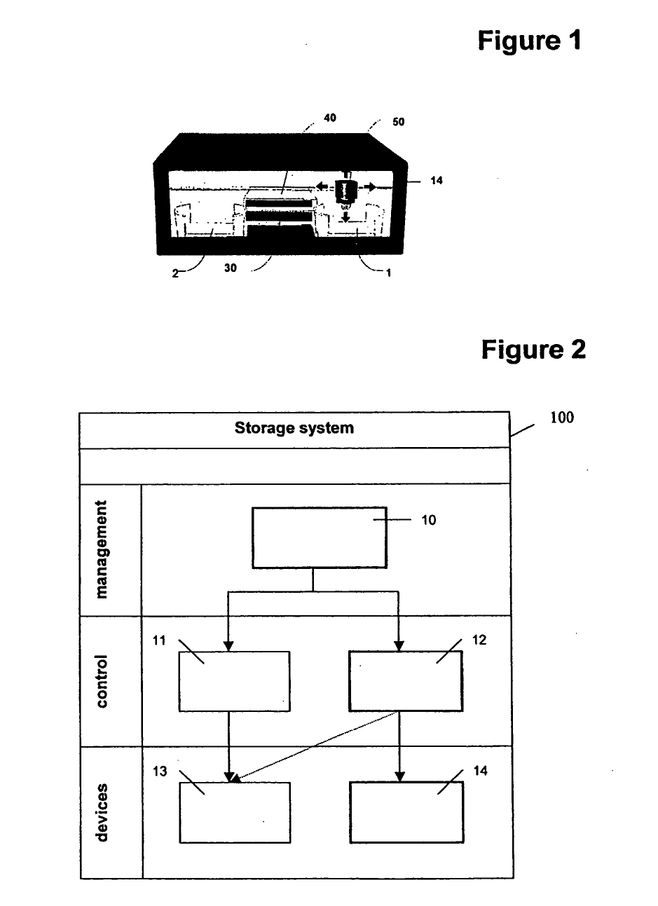

FIG. 1 shows a media transport unit 14 with two bins 1 and 2. The media transport unit 14 does not comprise separate slots for one single storage media unit, but only two bins, in which a plurality of storage media units can be stacked on top of each other. The media transport unit 14 comprises a number of data communication elements 30, in the following also called access or transfer elements, and generally at least one printing element 40 which is suitable for the storage media units which can be stored within the bins 1 and 2. Furthermore, the media transport unit comprises at least one grasp and transport mechanism 50. Such a grasp and transport mechanism 50 is able to move a storage media unit lying upmost within one of the bins 1, 2 from that bin to another location, as for example to the at least one printing element 40 or the at least one data communication element 30. The grasp and transport mechanism 50 can also grasp a storage media unit out from such device in order to transport it back to one of the bins 1 and 2. It is also possible that the grasp and transport mechanism 50 is able to grasp several storage media units at the same time.

FIG. 2 shows one embodiment of a storage system according to the present invention generally depicted with 100. The following description assumes a sample embodiment of a media transport unit similar to the media transport unit 14 illustrated in FIG. 1, including two bins 1, 2, each of which is capable of storing ten storage media units, one data access element, one printing element, and one grasp and transport mechanism. The grasp and transport mechanism is capable of gripping and transporting one storage media unit at a time.

The storage system comprises a data management system 10 being run on a computer system (not explicitly shown), a control unit 12 running on a computer system as well as a media transport unit 14 comprising associated data communication devices and printing devices. The media transport unit 14 is connected to the control unit 12. The control unit 12 offers the data management system 10 of the storage system exactly the same programming interface as it is offered by a control unit for media changers. As shown in FIG. 2 it is therefore possible that the control unit 12 can also control a conventional media changer 13 in parallel to the media transport unit 14. Therefore, a supplement control unit 11 for the media changer 13 can be avoided.

The data management system 10 sends requests to the control unit 12 for the media transport unit 14. The control unit 12 translates the requests into commands for the media transport unit 14. The control unit 12 for the media transport unit 14 performs this translation by means of a table holding information about the location of each of the storage media units stored in the bins of the media transport unit 14. In the case of a plurality of media transport units, there is exactly one such table for each of the controlled media transport units. The number of rows of the single table required for the sample embodiment of a single media transport unit as defined above is equal to ten because it is assumed that the media transport unit is not able to report the number of storage media units located in the bins and because the data access or printing elements shall not be used for storing storage media units. Each row of the table represents one storage element. By means of these virtual storage elements or slots, the control unit 12 for media transport unit 14 emulates the functionality of a standard storage media changer. The control unit 12 assigns the element addresses 1-10 to the virtual slots. Additionally, it assigns element address 1000 to the data access element 30, element address 2000 to the printing element 40, and element address 3000 to the grasp and transport element 50.

Each of the virtual slots can store exactly one storage media unit, or it may be empty. A virtual slot is said to store a storage media unit if the row of said table that corresponds to the virtual slot holds valid information about the actual location of one of the storage media units residing in one of the bins or in one of the other elements of the media transport unit 14. Each row of said table consists of three data fields holding the bin number, the relative position within the bin, and the element address of the element in which the corresponding storage media unit currently resides. Other data fields may be present in each row and may hold supplemental information about the corresponding storage media units. If the current element address field holds element address 0, which is a reserved and invalid address, the corresponding virtual slot is empty.

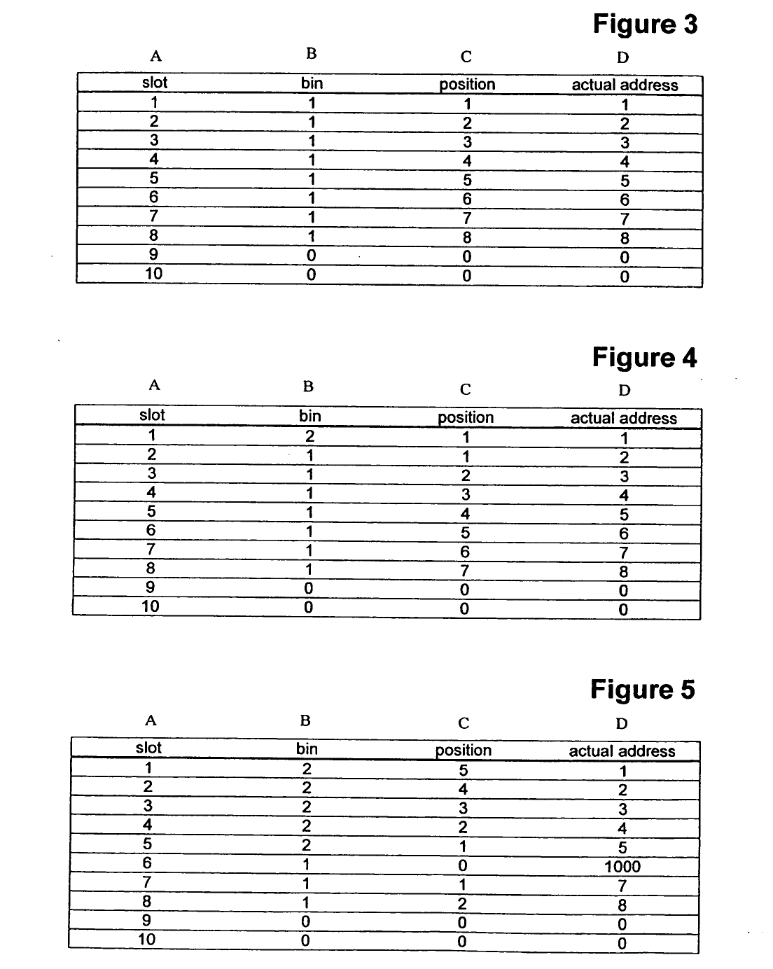

FIGS. 3 to 5 depict sequential writing, reading and updating steps with such a table that is generated, managed and updated by an embodiment of the control unit according to the invention.

FIG. 3 shows a table for a media transport unit with two bins in which ten storage media units can be stored, respectively. In the case shown here, bin 1 of the media transport unit is filled with eight storage media units. A table as shown in FIG. 3 shows ten rows, each row having a number indicating a virtual slot. Besides the row number for identification of a virtual slot, which can be assigned to exactly one storage media unit, further fields are provided in order to provide further position information about a specific storage media unit within the media transport unit. In column A of the table the virtual slot elements are indicated. In column B the bins are indicated in which a storage media unit which is assigned to a specific virtual slot is actually stored. Thereby the bins 1 and 2 are named by numbers 1 and 2, respectively. Zero is an indication that this corresponding virtual slot is not assigned to anyone of the storage media units. Column C indicates the position a storage media unit has within the corresponding bin which is indicated in column B. Column D designates the address of the location at which the storage media unit assigned to the corresponding virtual slot can actually be found. FIG. 3 shows the table in an initial state. Initially all storage media units of the media transport unit 14 are stored in bin 1 as indicated in column B. In this state all those storage media units are stacked upon each other, therefore successively taking up the positions 1 to 8. The element addresses of the corresponding virtual slots are also sequentially numbered from 1 to 8. Thus FIG. 3 illustrates the resulting table for a media transport unit in which 8 storage media units are available. Each of the rows 1-8 holds valid information about the actual location of one of the available 8 storage media units, and the rows 9 and 10 hold invalid information. Thus, the virtual slots 1-8, represented by rows 1-8, store a storage media unit, and the virtual slots 9 and 10 are empty.

In other embodiments, a table with the same number and meaning of fields can be used for media transport units with any arbitrary number and capacities of bins. Only the number of rows has to be changed accordingly.

When the control unit is started the next times, it loads the stored table from the non-volatile memory. Based on the information held in the data fields of the table, the control unit is capable of reporting the element status information to the data management system at any time.

FIGS. 4 and 5 show the sequential steps in the case that the storage media unit which is assigned to the virtual slot 6 should be moved out from the bin 1 to a data communication element with the element address 1000. FIG. 4 shows the first step when the storage media unit assigned to virtual slot 1 is removed from bin 1 out of its position 1, indicating that that storage media unit has been stored topmost within bin 1, to bin 2 which is empty and therefore the corresponding storage media unit gets therein position 1 as indicated in column C. This procedure is continued until the storage media unit assigned to virtual slot 6 can be accessed and removed from bin 1 to the data communication element with element address 1000. During this procedure all storage media units which were lying on top of the storage media unit assigned to virtual slot 6 within bin 1 are moved to bin 2 and stacked there on top of each other therefore successively taking up positions 1 to 5 within that bin.

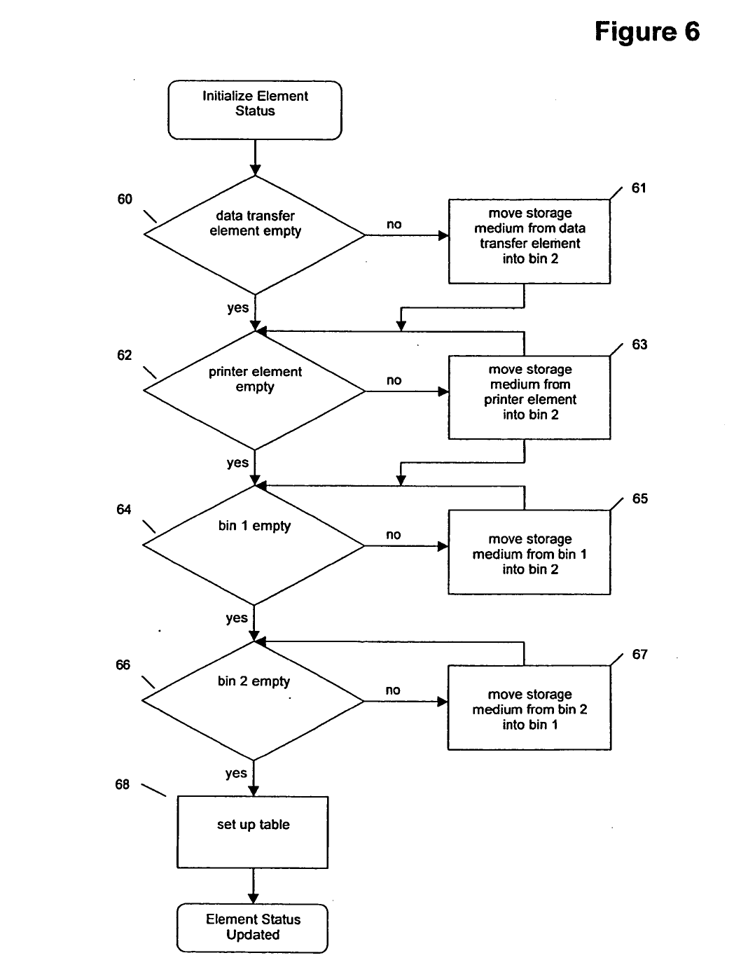

FIG. 6 shows a flowchart of an initialisation procedure when the control unit 12 for the media transport unit 14 is started the very first time. At this time, only the maximum capacity of the bins of the media transport unit 14 is known. Based on this information, the control unit 12 sets up the table as described with reference to FIG. 3. The number of storage media units that have manually been stored in the bins 1 and 2 by an operator is unknown and, thus all current element addresses are set equal to the invalid address value 0. The data management system 10 usually requests reporting the element status of any available element when it starts working with a media changer. At that time, the control unit determines the status information. FIG. 6 illustrates that procedure. First, the control unit checks the status of the data transfer/access (60) and the printing (62) elements and it moves (61/63) any storage media unit that are currently stored in these elements into bin 2. Then it moves (64/65) all storage media units currently stored in bin 1 into bin 2. Now, all storage media units available in the media transport unit are stored in bin 2. The control unit counts (66/67) the storage media units by moving them from bin 2 into bin 1, one after the other. Finally, the control unit updates (68) the table by assigning the available storage media units to the virtual slots and it stores the table in a non-volatile memory (e.g. in a hard disk volume). The assignment is performed by storing bin number, relative position and element address of the virtual slot in the data fields of the corresponding rows of the table. The assignment may be performed in any order, but a preferred embodiment assigns in ascending order of virtual slots. The topmost storage media unit with the relative position 1 is assigned to the virtual slot with element address 1. The next storage media unit with the relative position 2 is assigned to the virtual slot with element address 2, and so on.

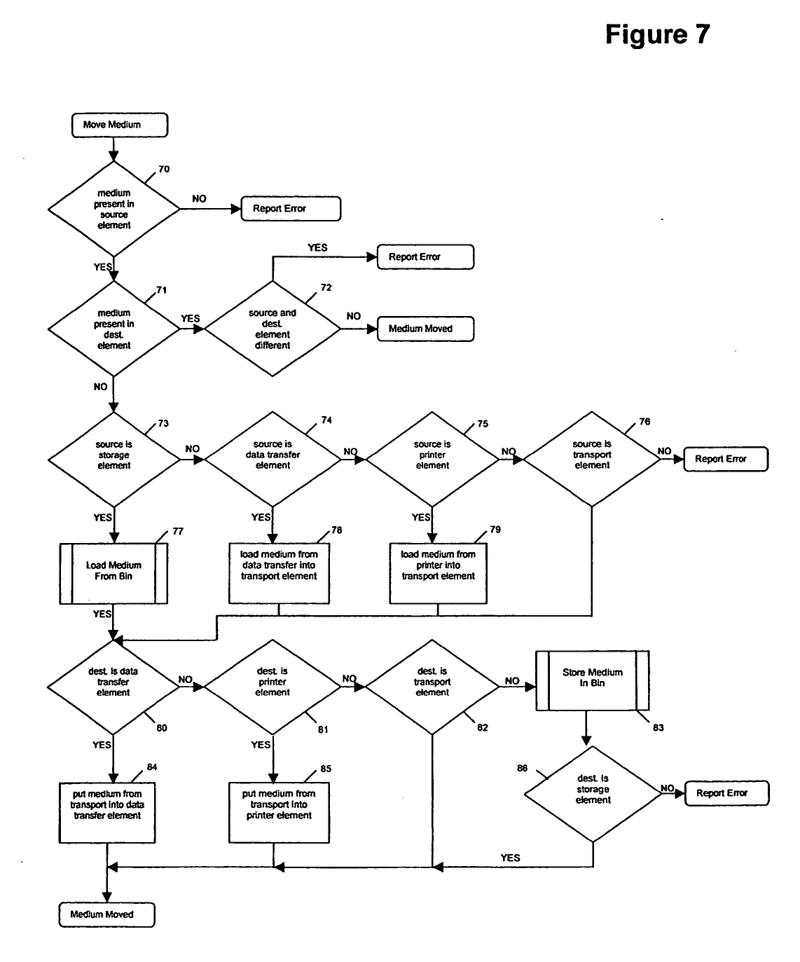

Working with a media changer means for the data management system to move storage media units between the various elements of the changer, e.g. in order to access data stored on a storage media unit or to print a label on the surface of a storage media unit. A particular move operation moves a storage media unit from a source element into a destination element. The related command takes various parameters. Mandatory parameters are the element addresses of the source and destination elements and of the media grasp and transport element that shall be used. Moving from an empty source element or moving into an occupied element, of which the element address is different from the source element address, is considered as an error. FIG. 7 illustrates the command for moving storage media units between elements. First, the control unit checks the element addresses and the state of the addressed elements (70/71/72). Next, the control unit determines the type of the addressed source element (73/74/75/76) and sends the appropriate loading commands to the media transport unit (77/78/79). After this step, the storage media unit has changed its current element address since it is now located in the media grasp and transport element. Therefore, the control unit updates the table and stores it in a non-volatile memory. Next, the control unit determines the type of the addressed destination element (80/81/82) and instructs the media transport unit to put the storage media unit at the desired location (83/84/85). After this step, the storage media unit has again changed its current element address since it is now located in the destination element. Therefore, the control unit updates the table and stores it in a non-volatile memory again.

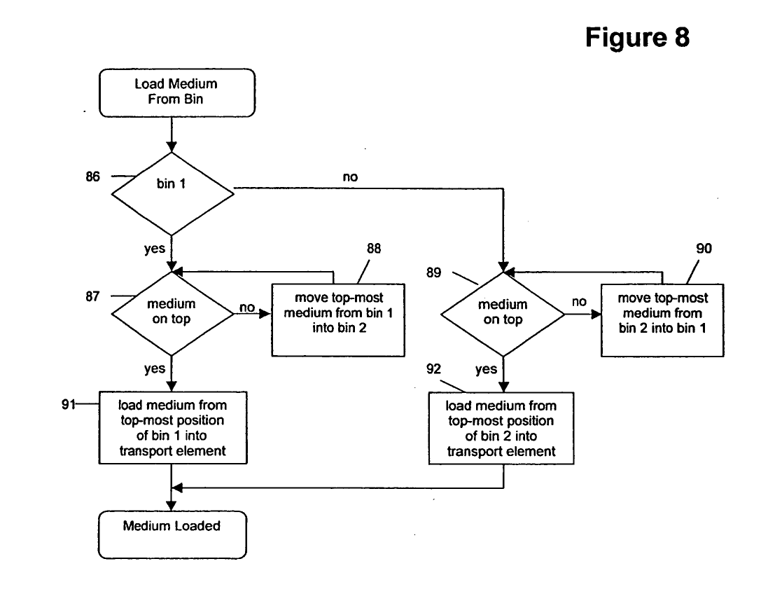

The routine for loading a storage media unit from a virtual slot is illustrated in FIG. 8. From the data fields of the table, the control unit determines the bin number and the position at which the related storage media unit is currently located in the particular bin. Any storage media unit placed on top of the addressed storage media unit is moved to the respective other bin. If, for example, the media transport unit and the table were in the state illustrated in FIG. 3, and the storage media unit located in virtual slot with element address 6 had to be moved into the data transfer/access element with element address 1000, the control unit would find the related storage media unit in bin 1 at position 6. The control unit would repeatedly move the topmost storage media unit, which is the storage media unit residing at position 1, from bin 1 into bin 2, and it would repeatedly update the table and store it in a non-volatile memory. FIG. 4 illustrates the state of the table after the first storage media unit had been moved. FIG. 5 illustrates the final state of the table. In the final state, the storage media unit from element 6 had been moved into element 1000.

In another embodiment of the present invention the media transport unit can provide more than 2 bins and additional storage elements like slots. The routine illustrated in FIG. 7 can be extended so that it can handle the additional storage elements as additional source or destination elements. The routine illustrated in FIG. 8 can be extended so that it moves a storage media unit placed on top of the addressed storage media unit to a particular one of a plurality of other bins, depending on the free capacity of the particular other bin, or to an additional storage element.

In a preferred embodiment, the routine for storing a storage media unit in a virtual slot does not apply any strategy for reducing the time required for loading frequently used storage media units. It simply puts the storage media unit on top of the other storage media units in the particular bin from which it has originally been loaded. FIG. 5 shows bin number 1 and position 0 in the related data fields of virtual slot 6. The invalid number 0 is assigned as position number because the related storage media unit is not currently located in a bin, but it resides in the data transfer/access element with element address 1000. The original bin number 1 is maintained as an indication for the storing routine.

1. A system comprising:
a data management system,
a media transport unit with a plurality of bins, each bin having a bin specific capacity for storing storage media units, at least one data processing unit and at least one loader mechanism for selectively moving a storage media unit from its actual location to another location within the media transport unit,
a number of storage media units, the number being smaller or equal to the sum of the bin specific capacities and further available storing capacities within the media transport unit reduced by the highest bin capacity, and
a control unit functionally interconnecting as programming interface said data management system and said media transport unit, the control unit being configured to emulate functionalities of a media changer with elective media access by generating, updating and managing a table, the table having a number of rows, the number of rows being equal to the sum of the bin specific capacities and further available storing capacities within the media transport unit reduced by the highest bin capacity, wherein each storage media unit is assigned to exactly one of those rows which are identified as unique virtual slots, respectively, each row further comprising fields to be continuously updated to provide actual position information about the respective storage media unit, so that in case of an requested access to a specific one of the number of storage media units the control unit can unambiguously determine the actual position of said storage media unit for that access can be achieved, if required, by an appropriate stock, transfer of the storage media units amongst the bins.

2. The system according to claim 1, wherein the position information can comprise an identity of a bin in which the respective storage media unit assigned to the respective row is actually located, a concrete position within said bin and an actual address of a location where the respective storage media unit is actually located within the media transport unit.

3. The system according to claim 1, wherein the bins and the positions within the corresponding bins are identified by an integer, respectively, whereby zero is placeholder for no bin and no position within a bin, respectively, thus indicating that the storage media unit assigned to the respective row is actually located at another location within the media transport unit, respectively, or that no storage media unit is actually assigned to the respective row.

4. The system according to claim 1, wherein the data processing unit comprises a data communication unit and/or a printing unit suitable for the number of storage media units.

5. The system according to claim 1, wherein the control unit is further configured to interconnect and control in parallel said data management unit and a conventional media changer.

6. The system according to claim 1, wherein the table is stored in a non-volatile memory accessible by the control unit.

7. The system according to claim 6, wherein the non-volatile memory is incorporated within the media transport unit.

8. The system according to claim 1, wherein the storage media units are sorted according to access frequency.

9. The system according to claim 1, wherein the table in each row comprises further ancillary information about the storage media unit assigned to said respective row.

10. The system according to claim 9, wherein the ancillary information comprises a bar code and/or a serial number and/or a volume tag and wherein the system further comprises a scanner unit usable to read the ancillary information.

11. The system according to claim 1, wherein the control unit is configured to generate the table so that an import/export element allowing an exchange of storage media units between the media transport unit and an external user can be emulated.

12. A method for controlling a data storage system comprising a data management system; a media transport unit with a plurality of bins, each bin having a bin specific capacity for storing storage media units, at least one data processing unit and at least one loader mechanism for selectively moving a storage media unit from its actual location to another location within the media transport unit; a number of storage media units, the number being smaller or equal to the sum of the bin specific capacities and further available storing capacities within the media transport unit reduced by the highest bin capacity, the method comprising the steps of:
providing a control unit functionally interconnecting as programming interface the data management system and the media transport unit,
generating a table to be managed and updated by the control unit, the table having a number of rows, the number of rows being equal to the sum of the bin specific capacities and further available storing capacities within the media transport unit reduced by the highest bin capacity,
assigning each storage media unit to exactly one of those rows,
identifying each row as a unique virtual slot,
providing each row with further fields to be continuously updated to provide actual position information about the respective storage media unit, so that in case of an requested access to a specific one of the number of storage media units the control unit can unambiguously determine the actual position of that storage media unit for that access can be achieved, if required, by an appropriate stock transfer of the storage media units amongst the bins.

13. The method according to claim 12, wherein the position information comprises an identity of a bin in which the respective storage media unit assigned to the respective row is actually located, a concrete position within that bin and/or an actual address of a location where the respective storage media unit is actually located within the system.

14. The method according to claim 12, wherein the bins and the positions within the corresponding bins are identified by an integer, respectively, whereby zero is placeholder for no bin and no position within a bin, respectively, thus indicating that the storage media unit assigned to the respective row is actually located at another location within the system, respectively, or that no storage media unit is actually assigned to the respective row.

15. The method according to claim 12, wherein the data processing unit comprises a data communication unit and/or a printing unit suitable for the number of storage media units.

16. The system according to claim 12, wherein the control unit is further used to interconnect and control in parallel the data management unit and a conventional media changer.

17. The method according to claim 12, wherein the table is stored in a non-volatile memory accessible by the control unit.

18. The method according to claim 17, wherein the non-volatile memory is incorporated within the media transport unit.

19. The method according to any claim 12, wherein the storage media units are sorted according to access frequency.

20. The method according to claim 12, wherein in each row of the table further ancillary information about the storage media unit assigned to that respective row is provided.

21. The method according to claim 20, wherein the ancillary information comprises a bar code and/or a serial number and/or a volume tag and wherein a scanner unit usable to read the ancillary information is provided.

22. The method according to claim 12, wherein the storage media units are chosen from the group consisting of CD, DVD, HD DVD, BD, MO, UDO, and PDD.

23. The method according to claim 12, wherein the storage media units are chosen as write-once storage media units or as rewriteable storage media units.

24. The method according to claim 12, wherein the table is generated so that an import/export element allowing an exchange of storage media units between the media transport unit and an external user can be emulated.

25. A computer-readable medium with a computer program stored thereon, the computer program comprising program coding means which are suitable for carrying out a method according to claim 12 when the computer program is run on a computer.

26. A computer program with program coding means which are suitable for carrying out a method according to claim 12 when the computer program is run on a computer.

27. A computer-readable medium with a computer program stored thereon, the computer program comprising program coding means which are suitable for carrying out a method according to claim 12 when the computer program is run on a computer.
